(19) United States
(12) Patent Application Publication
(10) Pub. No.: US 2012/0114803 A1
(43) Pub. Date: May 10, 2012

(54) COMESTIBLE FISH PRODUCT AND METHOD OF PRODUCING SAME

(75) Inventors: Michael E. Sirois, Portsmouth, NH (US); Richard Ly, St. John's (CA); Denise Gurshin, Exeter, NH (US)

(73) Assignee: High Liner Foods (USA) Incorporated, Portsmouth, NH (US)

(21) Appl. No.: 12/943,728

(22) Filed: Nov. 10, 2010

(51) Int. Cl. A23L 1/325; A23B 4/06

(52) U.S. Cl. 426/92; 426/524; 426/643

(57) ABSTRACT

The present invention is generally directed to a method for producing a frozen fish product from a whole fish fillet. The frozen fish product has many of the characteristics of a loin portion, including enhanced resistivity to partial thawing during the application of heat. The invention relates to a method for processing a fish and a comestible fish product produced thereby, wherein the method includes the steps of folding a whole fish fillet approximately in half and freezing the folded fish fillet, prior to subsequent external surface processing.

### FIELD OF THE INVENTION

This invention relates generally to frozen food products and, more particularly, to a method for producing a frozen fish product having a generally uniform thickness, and the frozen fish product produced thereby.

### BACKGROUND

It is commonly understood that certain cuts of meat from various portions of an animal command a higher sale price than cuts from another portion of the same animal. For example, in the seafood industry, a “loin” portion of a fish generally refers to the locally thicker portion of a fillet, proximate the backbone or spine. Such cuts frequently have a higher value than other portions of the fish. To provide a loin portion of commercially viable size, however, the fish must be of a certain minimum size. Some prior art methods are known to adjust thickness.

See, for example, in U.S. Pat. No. 7,384,330 and German Patent Publication No. DE 19806003, the entire disclosures of which are hereby incorporated by reference herein. U.S. Pat. No. 7,384,330 discloses methods and apparatus for providing a fillet of generally uniform thickness, by cutting a thick loin portion of a fish fillet and folding the resulting butterflied portion over a thin belly portion of the fillet. German Patent Publication No. DE 19806003 discloses a method of providing a fish fillet of a relatively uniform thickness and an approximately standard width, by folding in the thin belly and tapered tail regions of a fish fillet; In addition or instead, tapered and thick regions of successive fillets are overlapped.

Methods for creating reconstituted meat products of preselected shapes from multiple trims of meat are also well known, such as the methods disclosed in U.S. Pat. No. 6,248,381 and International Patent Application No. PCT/US2004/005597, the entire disclosures of which are hereby incorporated by reference herein. These methods bind together trims of meat via the freezing of a “purge” formed by liquid emitted by the rupture of cells present in the meat. Such methods, however, involve additional equipment, materials, and processing steps, which increase cost, and are not as desirable to consumers, many of whom prefer minimally-processed food products.

Some types of frozen meat products can have sear and/or grill marks applied thereto, to increase flavor and appearance. For example, known processes of applying localized grill marks to a frozen fillet of fish can be done effectively using high temperature grill irons pressed into the frozen fish fillet momentarily. Only a small amount of thermal energy is transferred to the frozen fish and in localized areas, maintaining the bulk of the fish in the frozen state for further processing and packaging.

One challenge is to create a more uniform and extensive sear, reminiscent of char broiling, to an entire surface of a frozen fish fillet. However, the high temperature involved and the duration of exposure to achieve the desire surface effect causes an increase in bulk temperature of the frozen fillet. Partial thawing of the fillet results in: (1) loss of volume and weight (due to melting/dripping water); and (2) partial cooking of the entire fillet, especially at the edges, rather than only having the upper surface seared. These characteristics are compounded when surface searing technique is applied to fillets of a fish species that are relatively thin (e.g., Tilapia). These impact the cost of goods and complicate downstream processing (e.g., the addition of a flavor coating and refreezing of the entire fillet).

### SUMMARY OF THE INVENTION

Examples of existing fish processing methods neither contemplate nor satisfy the combined needs of creating a fish portion with natural structure and texture in a size and configuration that transforms a relatively thin inexpensive starting fillet into a loin-type cut that is substantially thicker.

Accordingly, there is a need to transform thin flat fillets into more desirable, thicker loin-type cuts and optionally facilitate external surface processing to enhance consumer appeal.

In one aspect, the present invention is generally directed to a method for producing a minimally-processed frozen fish product from a whole fish fillet. The frozen fish product has many of the characteristics of a loin portion, including enhanced resistivity to partial thawing during the application of heat.

According to this aspect and related aspects, the invention relates to a method for processing a fish and a comestible fish product produced thereby, wherein the method includes the steps of providing a whole fish fillet having a lateral line generally disposed along a backbone of the fish, folding the whole fish fillet approximately in half, and freezing the folded fish fillet.

In various embodiments of the invention, the whole fish fillet may be skinned, deep skinned, or super deep skinned. Relatively flat whole fish fillets, such as Tilapia, may be used. In one embodiment, the whole fish fillet is folded along the lateral line; whereas, in another embodiment, the whole fish fillet is folded from head to tail. The fish fillet may be folded skin-side to-skin side. In one embodiment of the invention, the folded fish fillet has a minimum thickness of at least about 1.5 cm, whereas in another embodiment the folded fish fillet has a minimum thickness of about 1.9 cm.

The whole fish fillet may be trimmed after folding and prior to freezing, and may also be groomed for appearance prior to freezing. In one embodiment, a glaze (e.g., water with optional flavoring, tint, or other additive) is applied prior to or subsequent to freezing the folded fish fillet.

In various embodiments of the invention, the freezing step is accomplished by individual quick freezing, blast freezing, and/or tunnel freezing. In any of these embodiments, the folded fish fillet may be vacuum sealed prior to freezing. One embodiment of this aspect further includes providing, folding, and freezing a second whole fish fillet, wherein the folded fish fillets are frozen in a single layer, with spacing therebetween.

The invention further may include the step of processing at least a portion of an external surface of the frozen fish fillet. In various embodiments of this aspect, the processing may entail application of a marinade, searing, and/or char marking. As necessary, depending on the processing, the invention further includes the step of refreezing the processed fish fillet. The method may further include the step of cooking the processed frozen fish fillet.

In another aspect of the invention, the invention relates to a comestible fish product, wherein the comestible fish product is a whole fish fillet that has been folded approximately in half and frozen.

In one embodiment of the invention, the whole fish fillet is folded along a lateral line generally disposed along a backbone of the fish, whereas in another embodiment, the whole fish fillet is folded head to tail. The whole fish fillet is relatively flat prior to folding and may be Tilapia. The whole fish fillet may be skinned, deep skinned, or super deep skinned. In one embodiment of the invention, the folded fish fillet has been folded skin-side to skin-side. In various embodiments, the folded fish fillet has a minimum folded thickness of at least about 1.5 cm, or about 1.9 cm.

In one embodiment of the invention, the folded fish fillet has a groomed appearance, whereas in another embodiment, the folded fish fillet has a trimmed profile. In various embodiments of the invention, the folded fish fillet may be individually quick frozen, blast frozen, and/or and tunnel frozen. In any of these embodiments, the folded fish fillet may be vacuum sealed prior to freezing.

In one embodiment of this aspect, the fish fillet has a surface glaze and the surface glaze may be water with optional flavoring, tint, or other additive. In one embodiment of this aspect, the fish fillet has a processed external portion over at least a portion thereof. In various embodiments, the processed portion may be seared, marinated, and/or include char marking.

These and other objects, along with the advantages and features of the present invention herein disclosed, will become apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1A is a plan view of a whole fish fillet to be processed in accordance with various embodiments of the invention;

FIG. 1B is a plan view of another whole fish fillet to be processed in accordance with various embodiments of the invention;

FIG. 2A is a plan view of a folded fish fillet that is produced in accordance with one embodiment of the invention;

FIG. 2B is a plan view of a folded fish fillet that is produced in accordance with another embodiment of the invention;

FIG. 3 is a side view of a frozen fish fillet that is produced in accordance with one embodiment of the invention;

FIG. 4 is a plan view of multiple folded fish fillets that have been vacuum sealed in a single layer;

FIG. 5 is a plan view of a frozen fish fillet that has been further processed in accordance with one embodiment of the invention;

FIG. 6 is a schematic view of the further processing that is applied to a frozen fish fillet in accordance with one embodiment of the invention; and

FIG. 7 is a flow chart illustrating the processing method disclosed herein.

### DETAILED DESCRIPTION

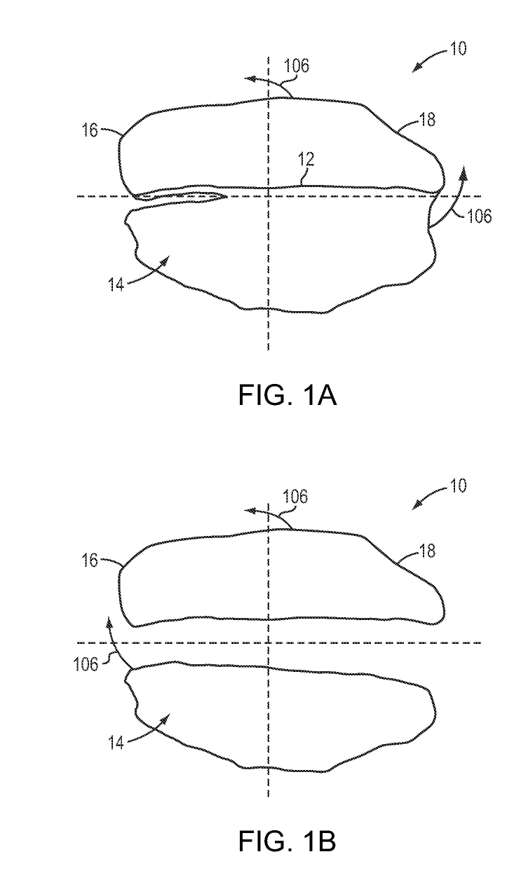

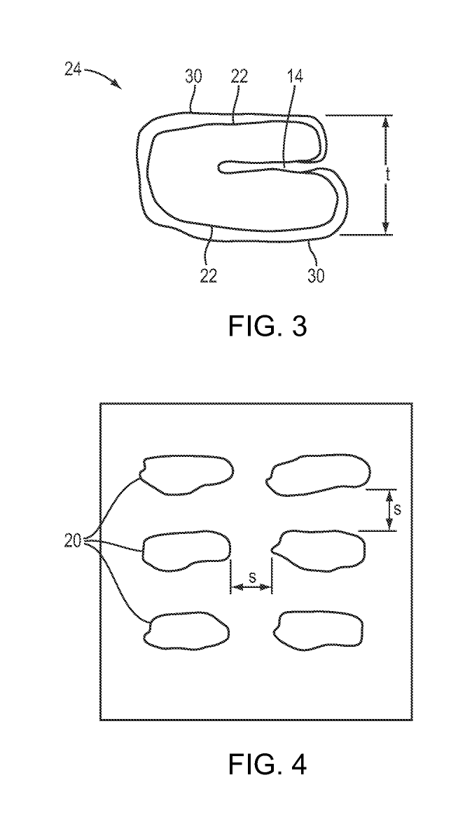

FIG. 1A is a plan view of a whole fish fillet 10 and FIG. 1B is a plan view of another whole fish fillet 10. As used herein, a “whole fish fillet” may refer to either a trimmed fillet, as shown in FIG. 1A, or two separated sides of a trimmed fillet, as shown in FIG. 1B. The whole fish fillet 10 defines a lateral line 12 generally disposed along a backbone of the fish, and has a skin side 14, a head end 16, a tail end 18, and an interior side 22 (best seen in FIG. 3). The whole fish fillet 10 may be skinned, deep skinned, or super deep skinned, and may be de-boned. Specifically, “deep skinned” fillets includes whole fillets 10 wherein some of the bloodline and fat flesh thereof have been removed, and “super deep skinned” includes whole fillets 10 wherein substantially all of the bloodline and fat flesh thereof has been removed. To prevent or reduce splitting of the tail end 18, removal of the bloodline may be terminated at some distance (for example, about 4 cm) from the terminus of the tail end 18. In one embodiment of the invention, the whole fish fillet 10 may be Tilapia or any other fish species producing a relatively thin or flat fillet.

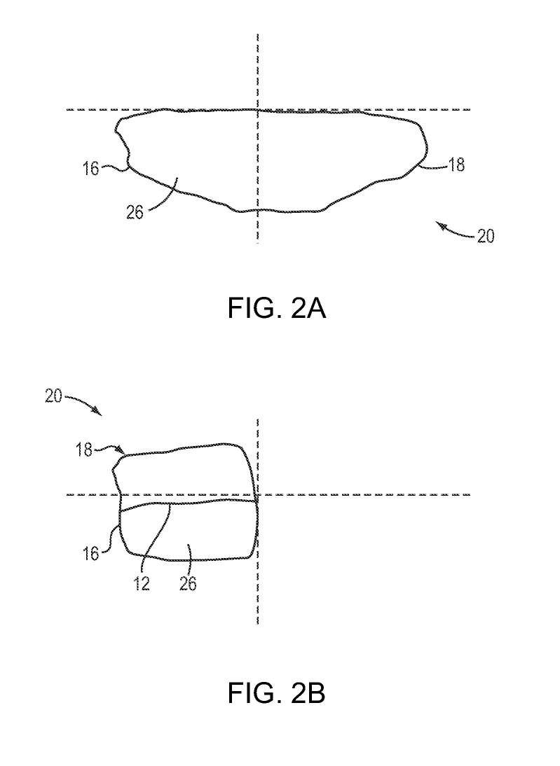

In accordance with the invention, the whole fish fillet 10 is folded approximately in half, producing a folded fillet 20. As discussed herein, “folding” includes both folding an intact fillet, such as that depicted in FIG. 1A, and stacking two separated sides of a fillet, such as that depicted in FIG. 1B, both producing a folded fillet 20. The folding may be along the lateral line 12, or may be from the head end 16 to the tail end 18. FIG. 2A is a plan view of a whole fish fillet 10 that has been folded along the lateral line 12, and FIG. 2B is a plan view of a whole fish fillet 10 that has been folded from the head end 16 to the tail end 18, both providing an exposed, external surface 26. In one embodiment of the invention, the folding is done such that the skin sides 14 of the two halves are in contact and the interior sides 22 form the exposed, external surface 26, as shown in FIG. 3.

The folded fillet 20 may have a minimum thickness “t” of at least about 1.5 cm at the thickest portion of the folded fillet 20. In another embodiment of the invention, the folded fillet 20 has a minimum thickness “t” of about 1.9 cm. Additionally, prior to freezing, the whole fish fillet 10 or the folded fillet 20 may be trimmed and/or groomed for appearance. For example, the whole fish fillet 10 or the folded fillet 20 may have the tail cropped or undesirable portions thereof removed, and the folded fillet 20 may be manipulated to tuck in one or more portions thereof, such that a generally uniform shape is formed. Depending on the shape and profile of the whole fish fillet 10 and amount of trimming and/or grooming, the folded fillet 20 may have a substantially uniform thickness or may be tapered and somewhat thinner at the open edges and ends. In any event, the thinnest part of the folded fillet 20 will be thicker than the thinnest part of the whole fillet 10, making the folded fillet 20 more suitable for subsequent processing.

In accordance with this aspect of the invention, the folded fillet 20 is then frozen. The freezing step may be accomplished by any method known in the art, including individual quick freezing (IQF), blast freezing, and tunnel freezing. Prior to freezing, multiple folded fillets 20 may be placed in a single layer, with spacing “s” between the fillets to avoid overlap, and are frozen at one time. The spacing “s” prevents the occurrence of two or more fillets becoming frozen to one another, which is undesirable for subsequent processing. In another embodiment of the invention, and as shown in FIG. 4, prior to freezing, one or more folded fillets 20 are first placed in a single layer, with spacing “s” between the fillets to avoid overlap, and are subsequently vacuum sealed. Vacuum sealing facilitates consolidation and compaction of the two halves of the folded fillet 20. It also removes air pockets, to reduce freezing time and allow for a more desirable and uniform appearance. Thus, the product of the freezing process is a frozen fillet 24. Optionally, a glaze 30 is applied prior to or subsequent to freezing, to reduce or prevent dehydration. In one embodiment of the invention, the glaze 30 is water, though any of a variety of aqueous and/or non-aqueous glazes can be applied, including optionally flavors, colors, nutrients, and/or other additives.

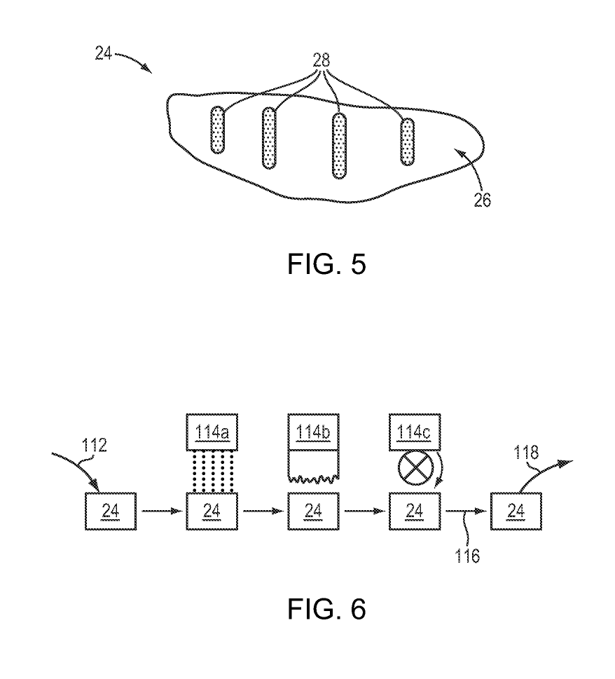

FIG. 5 is a plan view of a frozen fillet 24 that has been further processed in accordance with one embodiment of the invention. Specifically, the frozen fillet 24 may have at least a portion of an external surface thereof 26 further processed. Specifically, at least a portion of the external surface 26 may have a marinade applied thereto 114a, may have char marking applied thereto 114c, or may seared 114b, as depicted in FIG. 6. FIG. 5 shows char marking 28 that has been applied. Subsequent to having at least a portion of the external surface thereof 26 further processed, the frozen fillet 24 may be refrozen, to minimize the effects of any thermal transfer that occurred as a result of the further processing. Subsequent to freezing or refreezing, the frozen fillet 24 may be packaged for distribution 118, cooked, and eaten.

FIG. 6 is a schematic illustration of a process line for the further processing that the frozen fillet 24 may undergo. Specifically, after freezing 112, a frozen fillet 24 may have a marinade applied to at least a portion of an external surface thereof 114a. The marinade may be applied by any suitable method, such as dipping, spraying, etc. A crumb or breading coating may be applied, alternatively or additionally. The frozen fillet 24 may have a sear applied to at least a portion of an external surface thereof 114b, for example by exposure to a broiler or high intensity flame for a short duration. Lastly, char marking may be applied to applied to at least a portion of an external surface thereof 114c, for example with a high temperature platen or roller, or by flame impingement through a patterned mask. As will be readily understood any such external processing steps can occur solely or in combination and may occur in any order. The frozen fillet 24 may then be refrozen 116. Subsequent to freezing or refreezing, the frozen fillet 24 may be packaged for distribution 118.

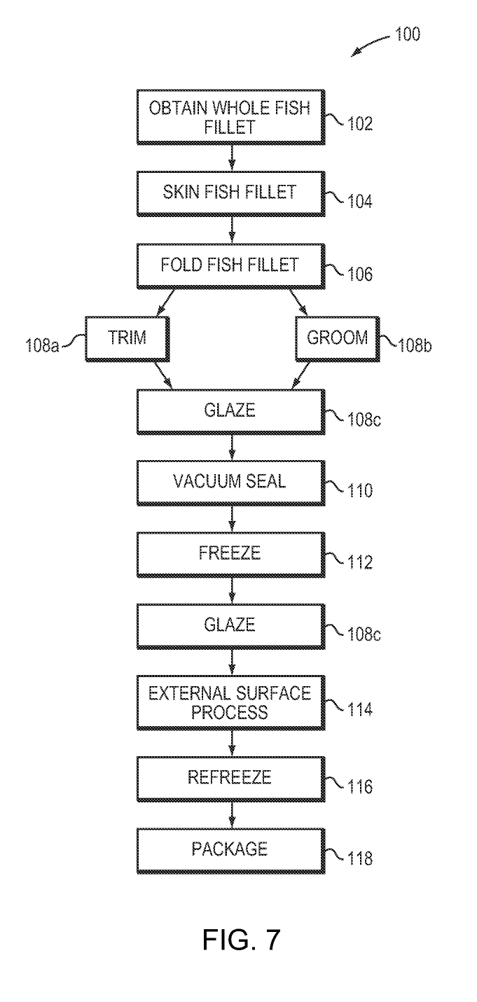

FIG. 7 is a flow chart illustrating one embodiment of the method 100 described above. Specifically, the method 100 includes obtaining a whole fish fillet 102, skinning the whole fish fillet 104, and folding the whole fish fillet 106. The process further includes any or all of optionally trimming 108a, grooming for appearance 108b, and/or 108c glazing the whole fish fillet or the folded fillet. The process includes optionally vacuum sealing the folded fillet 110, and freezing the folded fillet 112. The resulting frozen fillet may have at least a portion of an external surface thereof further processed 114, and may subsequently be refrozen 116, packaged 118, cooked, and eaten.

Accordingly, a relatively thin flat fish fillet, such as Tilapia, can be formed into a more substantial, thick loin-type portion. The increased thickness permits high temperature searing, char marking, and other processes to be performed effectively, without substantially increasing the bulk temperature (i.e., thawing) of the frozen fillet. Sole, flounder, and other thin flat fillets may be used, with similar advantageous results.

Having described certain embodiments of the invention, it will be apparent to those of ordinary skill in the art that other embodiments incorporating the concepts disclosed herein may be used without departing from the spirit and the scope of the inventions. The described embodiments are to be considered in all respects as only illustrative and not restrictive.

What is claimed is:

1. A method of processing fish comprising the steps of:
providing a whole fish fillet having a lateral line;
folding the whole fish fillet approximately in half; and
freezing the folded fish fillet.

2-24. (canceled)

25. A fish processed according to the method of claim 1.

26. A comestible fish product comprising a folded frozen whole fish fillet, wherein the frozen whole fish fillet is folded approximately in half.

27. The fish product of claim 26, wherein the frozen fish fillet is folded along a lateral line thereof.

28. The fish product of claim 26, wherein the frozen fish fillet is folded head to tail.

29. The fish product of claim 26, wherein the frozen fish fillet comprises Tilapia.

30. The fish product of claim 26, wherein the frozen fish fillet is skinned.

31. The fish product of claim 30, wherein the frozen fish fillet is super deep skinned.

32. The fish product of claim 26, wherein the frozen fish fillet has a minimum folded thickness of at least about 1.5 cm.

33. The fish product of claim 26, wherein the frozen fish fillet has a minimum folded thickness of about 1.9 cm.

34. The fish product of claim 26, wherein the frozen fish fillet comprises skin-side to skin-side folding.

35. The fish product of claim 26, wherein the frozen fish fillet comprises individually quick freezing.

36. The fish product of claim 26, wherein the frozen fish fillet comprises at least one of blast freezing and tunnel freezing.

37. The fish product of claim 26, wherein the frozen fish fillet comprises vacuum sealing prior to freezing;

38. The fish product of claim 26, wherein the frozen fish fillet comprises a trimmed profile.

39. The fish product of claim 26, wherein the frozen fish fillet comprises a groomed appearance.

40. The fish product of claim 26, wherein the frozen fish fillet further comprises a surface glaze.

41. The fish product of claim 40, wherein the glaze comprises water.

42. The fish product of claim 26, wherein the frozen fish fillet further comprises a processed external surface over at least a portion thereof.

43. The fish product of claim 42, wherein the processed portion comprises a sear.

44. The fish product of claim 42, wherein the processed portion comprises a marinade.

45. The fish product of claim 42, wherein the processed portion comprises a char marking.
